(19) United States
(12) Patent Application Publication
(10) Pub. No.: US 2010/0123836 A1
(43) Pub. Date: May 20, 2010

(54) IMAGE-PROJECTION SYSTEMS

(75) Inventors: Joe-Yu Wu, Hsinchu (TW); Yu-Tang Li, Hsinchu (TW); Hsin-Hsiang Lo, Hsinchu (TW); Chung-Yu Lai, Hsinchu (TW); Chun-Chuan Lin, Hsinchu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/273,651

(22) Filed: Nov. 19, 2008

(51) Int. Cl. H04N 9/31

(52) U.S. Cl. 348/744; 348/E09.025

(57) ABSTRACT

An image-projection system includes a light source, a light guide, and an image-projection module. The light source is configured to provide planar illumination. The light guide has a first end and a second end, with the first end being coupled with the light source to receive the planar illumination and the second end being configured to provide a transmitted planar illumination. The light guide may have an internal structure providing a reflective surface for reflecting the planar illumination received from the first end. The image-projection module may be coupled with the second end of the light guide and configured to receive an image signal input and project, in response to the image signal, an image via the transmitted planar illumination.

### TECHNICAL FIELD

The present disclosure generally relates to image-projection systems, and more particularly, to image-projection systems that may be implemented and installed in transportation systems.

### BACKGROUND

Image-projection systems have been implemented for various applications, such as offices, conferences, homes, and transportation systems, such as vehicles. In some applications with limited space, such as vehicles or other transportation systems, the space may be more limited. Other than the portability of the image-projection systems, other design considerations may include brightness, image size, image quality, space occupied and location of the system, heat dissipation, and safety. Development or implementation of an image-projection system may include one or more of these or additional design considerations. For example, using an overhead, single-unit projector, such as one designed for office or home uses, in a vehicle or other transportation system , or other application in which the available space is limited, may limit the ability to provide a large screen viewable by rear-seat or third-row passengers.

U.S. Pat. No. 7,275,832 to Sato illustrates examples of projection devices, as illustrated in FIG. 1. Referring to FIG. 1, the system includes box B for holding a projector mounted to vehicle C and screen S2 for reflecting and displaying an image. In some applications, there may be concerns that box B may move or fall due to frequent vibrations from moving vehicle C. Additionally, certain parts of the projector, such as a light source, may generate substantial amounts of heat in a closed cabin space. The heat may cause safety or product reliability concerns. Although one or more cooling fans may be implemented, the design may raise concerns such as noise, power consumption, and reduced portability.

FIG. 2 illustrates another prior art projection device illustrated in U.S. Publication No. 2007/0153237. Referring to FIG. 2, the device includes light source 102 and projector head 103 with optical fibers 4 connected between the two. The device may require complicated and expensive optical lenses at both light source 102 and projector head 103. In some cases, optical fiber 4 may have a diameter in the order of microns to tens of microns, and may require the use of coupling lenses 6, collimate lens 109, or both. The use of complicated and expensive lenses in some or all cases may increase both the design cost and manufacturing cost of the projection devices. Additionally, the overall size of the device is also increased.

Therefore, in some cases, it may be desirable to have image-projection systems that overcome or may be configured to overcome one or more problems of conventional systems.

### BRIEF SUMMARY

According to an embodiment of the present invention, an image-projection system is provided The image-projection system may include a light source, a light guide, and an image-projection module. The light source may be configured to provide planar illumination. The light guide has a first end and a second end, with the first end being coupled with the light source to receive the planar illumination and the second end being configured to provide a transmitted planar illumination. The light guide may have an internal structure providing a reflective surface for reflecting the planar illumination received from the first end. The image-projection module may be coupled with the second end of the light guide and configured to receive an image signal input and project in response to the image signal an image via the transmitted planar illumination.

According to another embodiment consistent with the present invention, there is provided an image-projection system including a light source, a light guide, and an image-projection module. The light source may be configured to provide illumination. The light guide has a first end and a second end, with the first end being coupled with the light source to receive the illumination and the second end being configured to provide a transmitted illumination. The light guide may have a single duct between the first end and the second end and may include an internal structure providing a reflective surface for reflecting the planar illumination received from the first end. The image-projection module may be coupled with the second end of the light guide and configured to receive an image signal input and project in response to the image signal an image via the transmitted planar illumination.

Consistent with the present invention, there is also provided an image-projection system including a light source, a light guide, and an image-projection module. The light source may be configured to provide planar illumination. The light guide may have a first end and a second end, with the first end being coupled with the light source to receive the planar illumination and the second end being configured to provide a transmitted planar illumination. The light guide may have a single duct between the first end and the second end and comprising an internal structure providing a reflective surface for reflecting the planar illumination received from the first end. The image-projection module may be coupled with the second end of the light guide and configured to receive an image signal input and project in response to the image signal an image via the transmitted planar illumination.

### BRIEF DESCRIPTION OF THE DRAWINGS

FIG. 1 illustrates a conventional projection device;

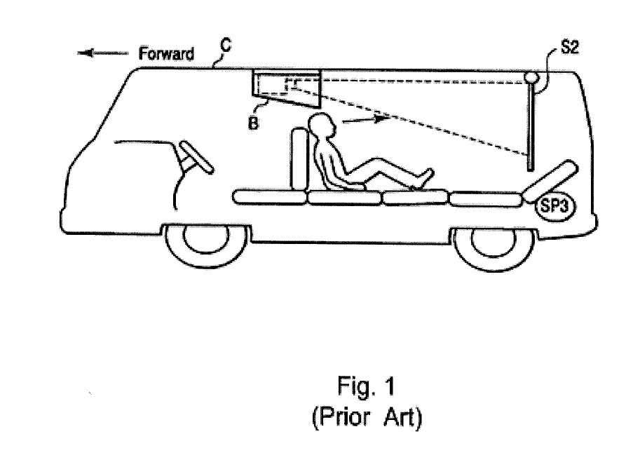

FIG. 2 illustrates another conventional projection device;

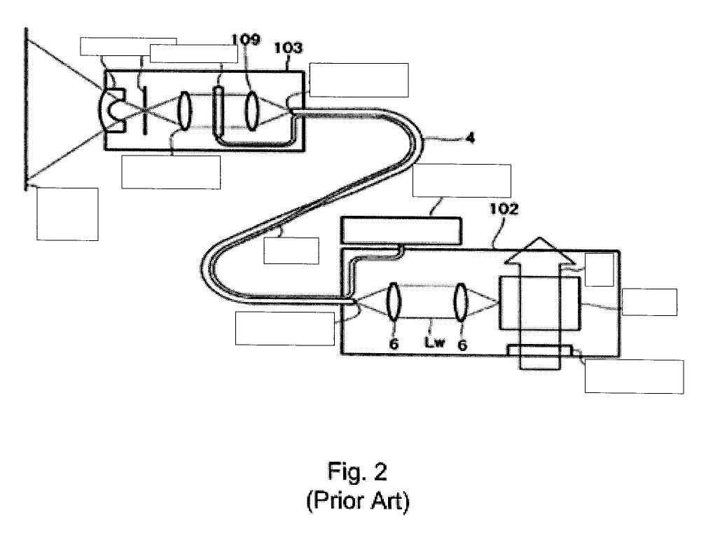

FIG. 3 illustrates an exemplary arrangement of an image-projection system, consistent with certain disclosed embodiments;

FIG. 4 illustrates an exemplary structure of an image-projection system and its light source, consistent with certain disclosed embodiments;

FIG. 5 illustrates another exemplary structure of an image-projection system and its a light source, consistent with certain disclosed embodiments;

FIG. 6 illustrates another exemplary structure of an image-projection system and its light source, consistent with certain disclosed embodiments; and

FIG. 7 illustrates an example of a light guide, consistent with certain disclosed embodiments.

### DETAILED DESCRIPTION

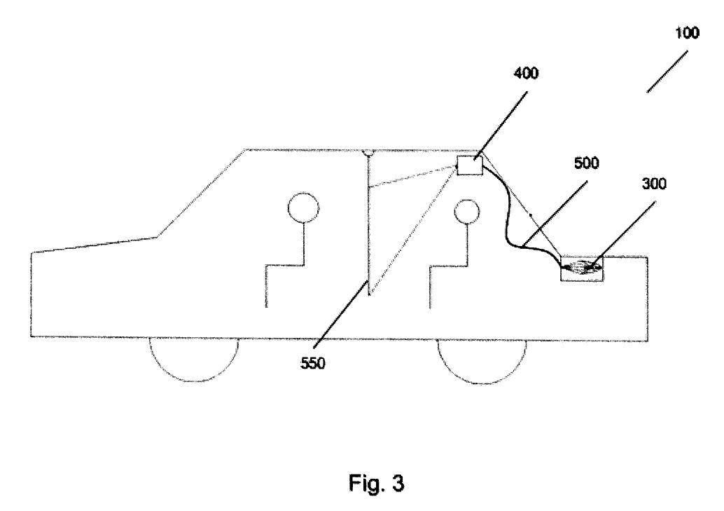

Referring to FIG. 3, an image-projection system 100 may include illumination unit or light source 300, image-projection module 400, and light guide 500. Light source 300 may be configured to provide planar illumination, such as illumination with uniform or similar brightness spread across a plane 550. Light source 300 may be placed remotely or away from image-projection module 400. For example, light source 300 may be placed in a trunk of a vehicle in one embodiment. The remote placement of light source 300 away from image-projection module may remove a source of heat generation from the passenger compartment and may avoid increasing the temperature in the passenger compartment or other heat-related safety concerns. Additionally, light source 300 may include a cooling fan or other active or passive cooling devices. The remote light-source arrangement may reduce or avoid other effects of the cooling devices, such as noise or air flow.

In one example, image-projection module 400 may be mounted to the vehicle, such as the inner roof of the vehicle. Image-projection system 100 may be installed in home, office, or conference spaces, as well as transportation systems, such as vehicles, airplanes, ships, and trains. For transportation devices incorporating image-projection system 100, system 100 may be mounted on passenger compartments, seats, or one of the surrounding walls or structures.

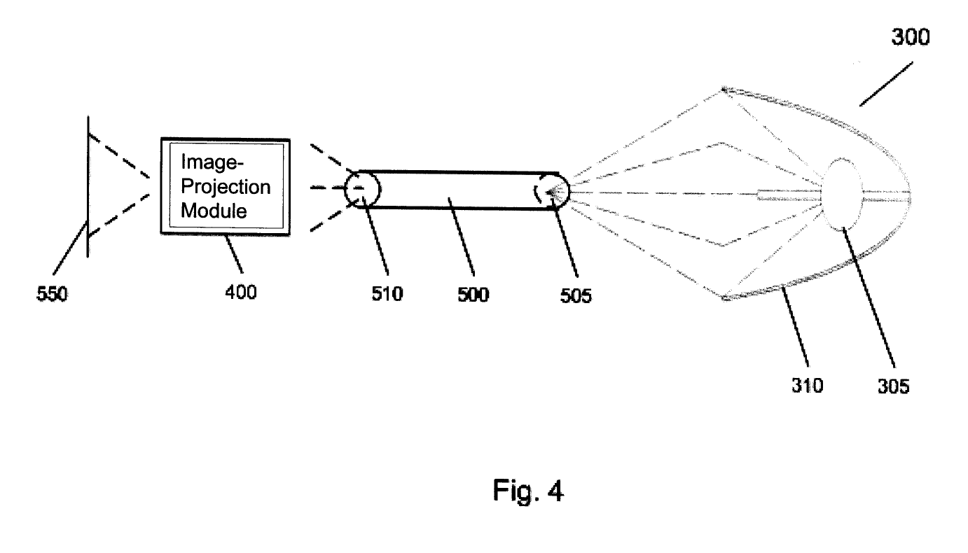

Referring to FIG. 4, light guide 500 may be used to guide light from light source 300 to image-projection module 400. In one embodiment, light guide 500 may have first end 505 and second end 510 and may be a single-duct light guide configured to provide a single duct between the two ends 505 and 510. First end 505 may be coupled with light source 300 to receive a planar illumination, and second end 510 may be configured to provide a transmitted planar illumination. Light guide 500 may include an internal structure providing a reflective surface for reflecting the planar illumination received from the first end. Image-projection module 400 may be coupled with second end 510 of light guide 500 and be configured to receive an image signal input, such as video or image signals, and project, in response to the image signal, an image via the transmitted planar illumination. The image-projection system may project the image on a wall or may include planar screen 550 for reflecting the projected image.

In one embodiment, light guide 500 may include a core, such as a waveguide for guiding the light from first end 505 to second end 510. Light guide 500 may also include an outer layer, such as cladding that can be made of a material with a lower refractive index compared to that of the core. The difference in the refractive index between the cladding and the core allows light guide 500 to provide complete or nearly complete internal reflection, thereby reducing light loss due to transmission. The design may guide the light down through light guide 500, which may have a straight path as illustrated or may have a winding path as would be the case, for example from a trunk to a passenger compartment.

Light source 300 may employ various structures to direct the light toward light guide 500 with reduced light loss. Referring to FIG. 4, light source 300 may include lighting unit 305 to generate light and reflector 310 coupled with the lighting unit 305. In some embodiments, lighting unit 305 may be a lamp, a laser diode or an LED array depending on the applications. In various embodiments, lighting unit may use one or more of different sources of illumination, such as metal lamp, halide lamp, a filament lamp, a fluorescent lamp, arc lamp, xenon lamp, organic or inorganic LED, laser diode, etc, either as a stand-alone unit or as a one- or two-dimensional array. Reflector 310 may provide a highly reflective surface to collect the light emitted by lighting unit 305. Reflectors 310 may have different designs or configurations based on various factors, such as lighting unit 305 used, the size of first end 505, the reflective characteristics or angles of light guide 500. Reflectors such as a focal reflector, a parabolic reflector or an elliptical reflector or other reflectors may be employed. Lighting unit 305 may be positioned at a focal point or designed location relative to reflector 310 to direct a majority of the illuminated light to light guide 500. In one embodiment, light reflected from reflector 310 and light emitted from lighting unit 305 may enter first end 505 of light guide 500 without relying on lenses, which may be complicated or expansive in some applications. The light is directed through light guide 500 and may provide planar light illumination at second end 510. In some embodiments, because the diameter of waveguide 515 may be in the order of several millimeters, light leakage at second end 505 may be reduced and a high coupling efficiency of illuminated light may be achieved.

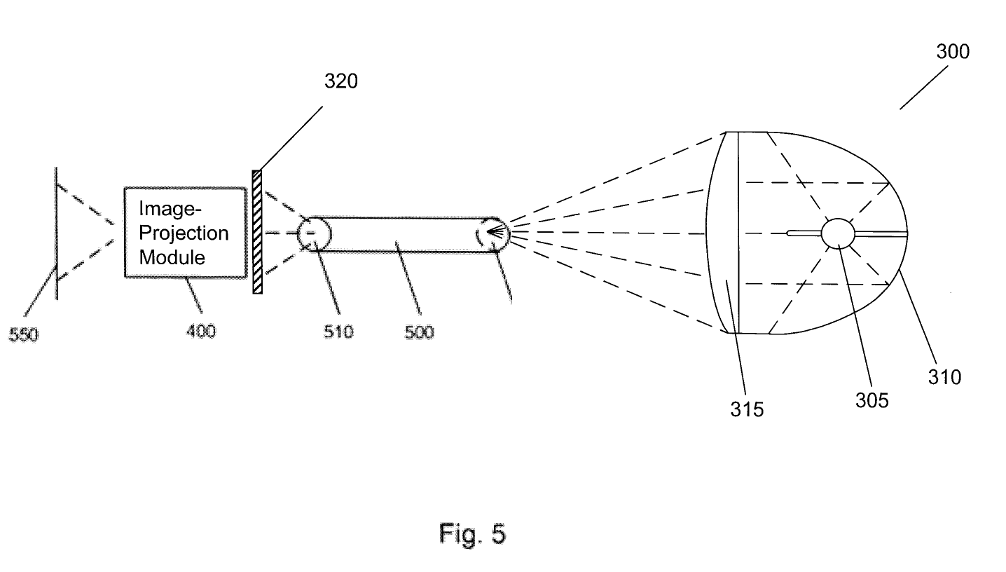

In another embodiment, light source 300 may include conversion or converging lens unit 315 and reflector 310 configured to collect emitted light, reflected light, or both, as illustrated in FIG. 5. Converging or conversion lens unit 315 may be configured to receive light from the lighting unit and direct the light to provide planar illumination. As an example, converging lens unit 315 may be a light collection lens, a linear or two-dimensional lens array, or other lens units configured to provide converge or collect light. Referring to FIG. 5, the lighting unit 305 may be positioned at a focal point of reflector 310, which direct the reflected light along paths substantially parallel to the optic axis of the collecting lens 315. The light is then routed or converged into first or input end 505.

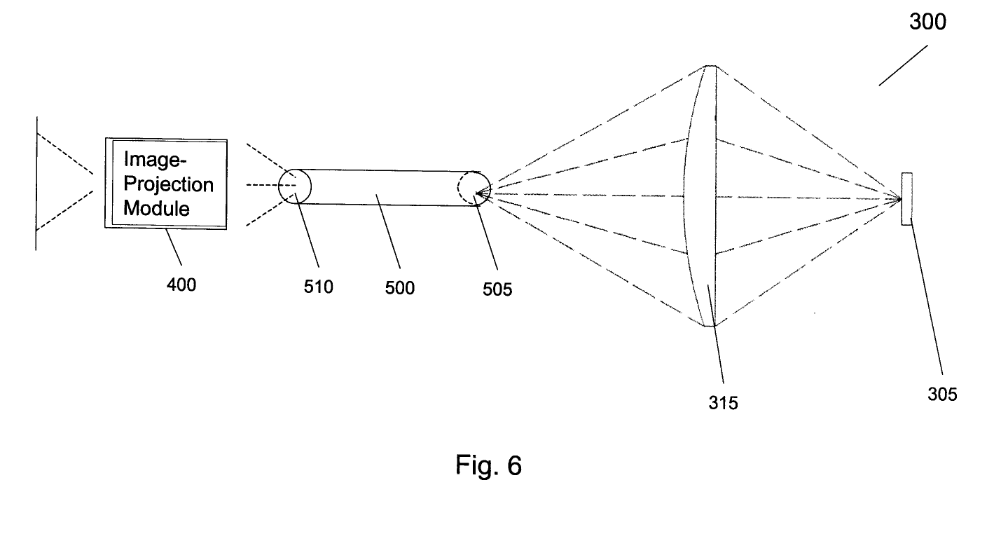

Referring to FIG. 6, lighting unit 305 may be a planar light source or an illumination array. For example, an array having two or more light emitting diodes (LEDs) may serve as a planar light source. To direct light toward first or input end 505 of light guide 500, a lens or lens unit, such as a compound parabolic concentrator (CPC), may be employed. Light rays emitted from different locations may enter the lens unit or CPC from various directions or with a wide range of angles of incidence but exit within a relatively small angle toward first or input end 505.

In some embodiments, light entered from first input 505 is directed through light guide 500. The large diameter of waveguide 515 may provide planar illumination 320 at second or output end 510 of light guide 500. Planar illumination 320 may provide a suitable light for image projection. Compared to an output of a point light source, planar illumination may avoid the need for a collimate lens in some embodiments, thereby providing the possibility of simplifying the design and reducing the overall cost and complexity. Moreover, light guide 500 may operate by total internal reflection and provide a relatively high efficiency of light transmission. In one embodiment, an optical lens unit, such as an optical integrator or a lens array, may still be used at output end 510 or within image-projection module 400, such as along the optical axis of planar illumination 320. In one embodiment, the optical lens unit may serve to homogenize the light from planar illumination 320 to improve or adjust the uniformity of light distribution.

In some embodiments, because of the relatively larger diameter of waveguide 515, converging lens unit 315 at input end 505 and optical lens unit at output end 510, if used, may be simplified. The flexibility in having no lens or a simplified lens design may reduce the cost of design and manufacturing.

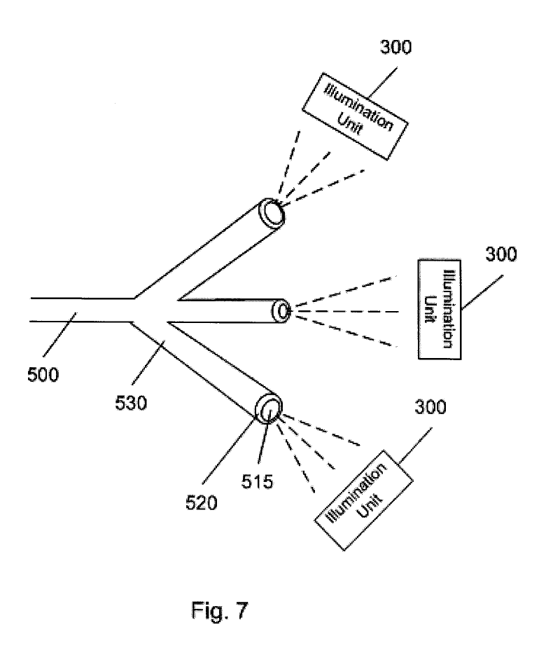

Referring to FIG. 7, image-projection system 100 may include two or more light sources, such as three illumination units 300 as illustrated in FIG. 7. Accordingly, light guide 500 may have multiple input ends or branches 530, each being coupled with an illumination unit. The input ends 505 may be aligned with the optical axis of corresponding illumination unit. The light from different input ends may travel through and be combined by light guide 500, with its combined effect provided at an output end. As discussed earlier, because the refractive index of waveguide 515 is higher than that of cladding 520, light may be transmitted through total internal reflection with little light loss. And the illumination and light guide may be configured to provide planar illumination at the output end of light guide 500. As alternative embodiments, a light guide may be configured to have one input end and two or more output ends for two or more image-projection modules. It may also be configured to have two or more input ends and two or more output ends for two or more image-projection modules

It will be apparent to those skilled in the art that various modifications and variations can be made to the systems and embodiments disclosed. The disclosed systems and embodiments are exemplary only. The following claims and their equivalents are indicative of the scope of the embodiments.

What is claimed is:

1. An image-projection system comprising:
a light source configured to provide planar illumination;
a light guide having a first end and a second end, the first end being coupled with the light source to receive the planar illumination and the second end being configured to provide a transmitted planar illumination, the light guide comprising an internal structure providing a reflective surface for reflecting the planar illumination received from the first end; and
an image-projection module coupled with the second end of the light guide and configured to receive an image signal input and project, in response to the image signal, an image via the transmitted planar illumination.

2. The image-projection system of claim 1, wherein the light guide comprises a single-duct light guide configured to provide a single duct between the first end and the second end.

3. The image-projection system of claim 1, wherein the at least one light source comprises a lighting unit, a reflector coupled with the lighting unit.

4. The image-projection system of claim 3, wherein the lighting unit comprises one of a metal lamp, halide lamp, filament lamp, fluorescent lamp, arc lamp, xenon lamp, light emitting diode (LED), laser, organic light emitting diode (OLED), and a light array.

5. The image-projection system of claim 1, wherein the light source is placed at a remote location away from the image-projection module.

6. The image-projection system of claim 1, wherein the image projection system is installed in a transportation system comprising one of a vehicle, an airplane, a ship, and a train.

7. The image-projection system of claim 3, wherein the light source further comprises a conversion lens unit configured to receive light from the lighting unit and direct the light to provide a planar illumination.

8. The image-projection system of claim 1, wherein the light guide comprises a waveguide with an external cladding, the cladding having a refractive index lower than a refractive index of the waveguide.

9. The image-projection system of claim 1 further comprising a screen for reflecting the projected image.

10. The image-projection system of claim 1, wherein the light guide has at least one input opening at the first end and at least one output opening at the second end.

11. An image-projection system comprising:
a light source configured to provide illumination;
a light guide having a first end and a second end, the first end being coupled with the light source to receive the illumination and the second end being configured to provide a transmitted illumination, the light guide having a single duct between the first end and the second end and comprising an internal structure providing a reflective surface for reflecting the planar illumination received from the first end; and
an image-projection module coupled with the second end of the light guide and configured to receive an image signal input and project, in response to the image signal, an image via the transmitted planar illumination.

12. The image-projection system of claim 11, wherein the single-duct between the first end and the second end has at least one input opening at the first end and at least one output opening at the second end.

13. The image-projection system of claim 11, wherein the at least one light source comprises a lighting unit, a reflector coupled with the lighting unit.

14. The image-projection system of claim 13, wherein the lighting unit comprises one of a metal lamp, halide lamp, filament lamp, fluorescent lamp, arc lamp, xenon lamp, light emitting diode (LED), laser, organic light emitting diode (OLED), and a light array.

15. The image-projection system of claim 13, wherein the light source further comprises a conversion lens unit configured to receive light from the lighting unit and direct the light to provide a planar illumination.

16. The image-projection system of claim 11, wherein the light source is placed at a remote location away from the image-projection module.

17. The image-projection system of claim 11, wherein the image projection system is installed in a transportation system comprising one of a vehicle, an airplane, a ship, and a train.

18. The image-projection system of claim 11, wherein the illumination comprises a planar illumination and the transmitted illumination comprises a transmitted planar illumination.

19. The image-projection system of claim 11, wherein the light guide comprises a waveguide with an external cladding, the cladding having a refractive index lower than a refractive index of the waveguide.

20. The image-projection system of claim 11 further comprising a screen for reflecting the projected image.

21. An image-projection system comprising:
a light source configured to provide planar illumination;
a light guide having a first end and a second end, the first end being coupled with the light source to receive the planar illumination and the second end being configured to provide a transmitted planar illumination, the light guide having a single duct between the first end and the second end and comprising an internal structure providing a reflective surface for reflecting the planar illumination received from the first end; and
an image-projection module coupled with the second end of the light guide and configured to receive an image signal input and project, in response to the image signal, an image via the transmitted planar illumination.

22. The image-projection system of claim 21, wherein the light source further comprises a conversion lens unit configured to receive light from the lighting unit and direct the light to provide a planar illumination.

23. The image-projection system of claim 21, wherein the light guide has at least one input opening at the first end and at least one output opening at the second end.
